(19) United States
(12) Patent Application Publication
(10) Pub. No.: US 2015/0326003 A1
(43) Pub. Date: Nov. 12, 2015

(54) Earth Leakage Circuit Breaker

(71) Applicant: MT&C CO., LTD., Daejeon (KR)

(72) Inventor: Jaeseong Yu, Daejeon (KR)

(21) Appl. No.: 14/389,713

(22) PCT Filed: Sep. 25, 2012
(86) PCT No.: PCT/KR2012/007691

§ 371 Date: Sep. 30, 2014

(30) Foreign Application Priority Data
Aug. 7, 2012 (KR) 10-2012-0086457

(51) Int. Cl. H02H 3/16

(52) U.S. Cl. CPC H02H 3/16

(57) ABSTRACT

An earth leakage circuit breaker is described, comprising: a main power cutoff unit connected between the main power supply line and a load; a zero phase sequence current transformer which detects earth leakage occurring in the main power line and outputs a voltage having an amplitude corresponding to the earth leakage to a first output terminal and to a second output terminal; a protective unit which limits the amplitude of the voltage supplied by the zero phase sequence current transformer to a level lower than a preset value and outputs the voltage; and an earth leakage detection unit which outputs an earth leakage detection signal for driving the main power cutoff unit so as to control the cutoff of the power being supplied to the load when there is a difference between the voltages outputted by the protective unit.

### CROSS-REFERENCE TO RELATED APPLICATIONS

This application is the U.S. national phase of International Patent Application No. PCT/KR2012/007691 filed Sep. 25, 2012, which claims the benefit of Korean Patent Application No. 10-2012-0086457 filed Aug. 7, 2012, the entire content of which is incorporated herein by reference.

### FIELD OF THE INVENTION

The present disclosure relates to an earth leakage circuit breaker.

### BACKGROUND

Generally, factors that operate an earth leakage circuit breaker in a circuit for supplying power include a surge voltage induced on a power line due to lightning, a short circuit, and an electric shock, in addition to an actual leakage current.

However, when a surge voltage caused by lightning flows through the ground into a power line, or flows into a load such as an electronic device or an electrical device, an earth leakage circuit breaker erroneously detects the surge voltage as a leakage current due to an electric field generated by the surge voltage. Therefore, a problem arises in that the earth leakage circuit breaker malfunctions, although a present state is not an earth leakage state in which the earth leakage circuit breaker should be normally operated.

Due to this, there is a problem that power supplied from the power line to a load is cut off due to the malfunctioning of the earth leakage circuit breaker, although the power line is in a normal state.

A conventional earth leakage circuit breaker is typically operated within a time of 20 ms until a leakage current is detected and power is cut off, and is suitably operated such that, in the case of a high-sensitive earth leakage circuit breaker, a breaking speed for earth leakage protection is within 0.03 seconds (30 ms) when a leakage current is 30 mA, and in the case of a medium-sensitive circuit breaker, a breaking speed is 0.1 second (100 ms) when the leakage current is 100 mA. However, in a place where the insulation of a load or the like is unstable, the circuit breaker is very sensitively operated, erroneously recognizes a surge voltage as a leakage current and then performs a trip recognition, due to the induction of a surge voltage caused by lightning and the malfunctioning of the circuit breaker caused by an impulsive wavelength, thus frequently causing a case where the operation of a load device is stopped.

That is, although an instantaneous leakage current flowing within a time of several ms does not adversely affect a load, the earth leakage circuit breaker is unnecessarily operated to cut off the power to be supplied to the load, thus stopping the operation of an electronic device and inconveniencing a user.

In this way, the earth leakage circuit breaker is used to protect a load and prevent a human body from getting shocked. However, as described above, when the earth leakage circuit breaker malfunctions and causes the operation of a load to be unnecessarily stopped due to a surge voltage or instantaneous noise, a serious economic loss may be incurred, especially in the case where the operation of industrial equipment is unnecessarily stopped.

### SUMMARY

Embodiments disclosed herein prevent an earth leakage circuit breaker from malfunctioning due to a surge voltage, thus improving the reliability of the earth leakage circuit breaker.

An earth leakage circuit breaker according to an embodiment comprises a main power cutoff unit connected between main power lines supplied with power and a load, a zero-phase current transformer connected to the main power lines and configured to detect a leakage current generated on the main power lines and output voltages having magnitudes corresponding to the detected leakage current through first and second output terminals, a protection unit connected to the zero-phase current transformer and configured to limit the magnitudes of the voltages output from the zero-phase current transformer to a preset value or less and output limited voltages, and an earth leakage detection unit connected to the protection unit and configured to, when a difference between the voltages output from the protection unit occurs, output an earth leakage detection signal for driving the main power cutoff unit and then controlling cutoff of the power applied to the load.

The protection unit may comprise a first diode and a second diode connected to the output terminals of the zero-phase current transformer and to the earth leakage detection unit in opposite directions.

The preset value may be a threshold voltage of the first and second diodes.

The protection unit may further comprise a first resistor connected at a first end of the first resistor to the first output terminal of the zero-phase current transformer and connected at a second end of the first resistor to a cathode of the first diode, and a second resistor connected at a first end of the second resistor the second output terminal of the zero-phase current transformer and connected at a second end of the second resistor to a cathode of the second diode, wherein an anode of the first diode is connected to the cathode of the second diode, and an anode of the second diode is connected to the cathode of the first diode.

The earth leakage circuit breaker may further comprise a control signal output unit connected to the earth leakage detection unit and configured to control an operating state of the control signal output unit in response to a state of the earth leakage detection signal output from the earth leakage detection unit, a switching unit provided with a relay for initializing the earth leakage detection unit and the control signal output unit, and a capacitor for maintaining an operating time of the relay, a trip driving unit connected to the main power lines and configured to operate the main power cutoff unit depending on operating states of the control signal output unit and the switching unit and then cut off power the that is supplied from the main power lines to the load, and a rectifier connected to the main power lines and the trip driving unit and configured to supply power to the earth leakage detection unit and to the switching unit.

The relay may comprise a coil, a third switch configured to change a state of a contact with the earth leakage detection unit and to initialize the earth leakage detection unit when current flows through the coil, and a fourth switch configured to change a state of a contact with the control signal output unit and to initialize the control signal output unit when current flows through the coil.

The switching unit may be configured to operate the relay during a time in which the capacitor is discharged, and may be configured to, when a leakage current is detected by the zero-phase current transformer during a time in which the relay is operated, operate the trip driving unit and then cut off the power that is supplied from the main power lines to the load.

The switching unit may be connected both to the capacitor and to the control signal output unit, and may be operated to display a leakage current generation state when the control signal output unit is operated.

The operating state display unit may comprise a light emitting diode (LED).

The operating state display unit may further comprise a number-of-leakages output unit for counting a number of times that the LED is turned on or turned off, and outputting the counted number of times.

The rectifier may be a bridge rectification circuit.

The rectifier may comprise eight diodes connected in series.

In accordance with the above features, when a leakage current is detected again within a designated time after a leakage current has been initially detected, it is determined that the leakage current has occurred, and main power that is supplied to main power lines is cut off, thus preventing the earth leakage circuit breaker from being unnecessarily operated due to an instantaneous leakage current that does not adversely affect the operation of a load connected to the main power lines. Accordingly, the operation of the earth leakage circuit breaker, which frequently occurs regardless of a load protection operation, is prevented, thus reducing the inconvenience of a user and improving the reliability of the earth leakage circuit breaker.

Further, by means of the operation of a state display unit, the state of the generation of a leakage current, such as the generation or non-generation of a leakage current and the number of times the leakage current is generated, may be checked by a user, and thus the user's convenience may be improved.

### BRIEF DESCRIPTION OF THE DRAWINGS

FIG. 1 is a circuit diagram showing an earth leakage circuit breaker according to an embodiment disclosed herein; and

FIG. 2 is a timing diagram showing the operation timing of the earth leakage circuit breaker according to an embodiment disclosed herein.

### DETAILED DESCRIPTION

Embodiments are described in detail with reference to the accompanying drawings so that those having ordinary knowledge in the technical field to which the disclosure pertains can easily practice the present invention. However, embodiments may be implemented in various different forms and are not limited to the embodiments described here.

An earth leakage circuit breaker according to an embodiment will be described with reference to the accompanying drawings.

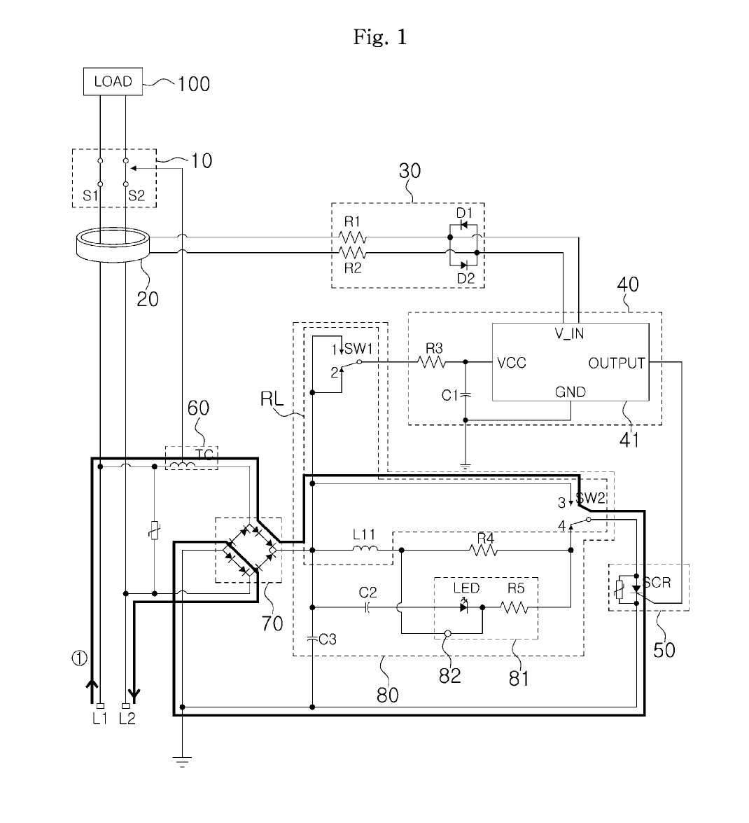

First, an earth leakage circuit breaker will be described with reference to FIG. 1.

The earth leakage circuit breaker according to an embodiment comprises first and second main power lines L1 and L2 supplied with commercial power and connected to a load 100, a main power cutoff unit 10 connected to the first and second main power lines L1 and L2, a zero-phase current transformer connected to the two main power lines L1 and L2, a protection unit 30 connected to the zero-phase current transformer 20, an earth leakage detection unit 40 connected to the protection unit 30, a control signal output unit 50 connected to the earth leakage detection unit 40, a trip driving unit 60 connected to the main power cutoff unit 10, a rectifier 70 connected to the trip driving unit 60, and a switching unit 80 connected both to the rectifier 70 and to the control signal output unit 50.

The main power cutoff unit 10 comprises a first switch S1 and a second switch S1 arranged in portions of the first and second main power lines L1 and L2 interposed between commercial power and the load 100.

The turned-on and turned-off states of the first and second switches S1 and S2 of the main power cutoff unit 10 are controlled in response to a trip signal input from the trip driving unit 50.

When the first and second switches S1 and S2 are turned on, the power applied from the first and second main power lines L1 and L2 is supplied to the load 100, so that drive power for driving the load 100 is supplied to the load 100, thus enabling the load 100 to be normally operated.

However, when the first and second switches S1 and S2 are turned off, the power applied from the first and second main power lines L1 and L2 is cut off by the first and second switches S1 and S2 to stop the operation of the load 100.

The main power lines L1 and L2 connected to the main power cutoff unit 10 penetrate through a center portion of the zero-phase current transformer 20.

Such a zero-phase current transformer 20 detects the intensity of a magnetic field generated from the main power lines L1 and L2, generates voltages having certain magnitudes between both the output terminals of the zero-phase current transformer 20, and applies the generated voltages to the protection unit 30.

The protection unit 30 comprises a first resistor R1 connected at one end of the first resistor R1 to one output terminal of the zero-phase current transformer 20, a second resistor R2 connected at one end of the first resistor R2 to the other output terminal of the zero-phase current transformer 20, a first diode D1 connected at the cathode of the first diode D1 to the other end of the first resistor R1, and a second diode D2 connected at the anode of the second diode D2 to the other end of the first resistor R1 and connected at the cathode the second diode D2 both to the other end of the resistor R2 and to the anode of the first diode D1.

The first resistor R1 and the second resistor R2 of the protection unit 30 primarily drop the voltages generated by the zero-phase current transformer 20.

The first diode D1 and the second diode D2 connected in opposite directions function to limit the magnitudes of the voltages applied from the zero-phase current transformer 20 to the earth leakage detection unit 40 to a forward voltage, which is a predetermined value (i.e., a threshold voltage) (e.g., about 0.3 V to 1.2 V), or less. In this case, the forward voltage varies depending on the type of first and second diodes D1 and D2.

The protection unit 30 limits the magnitudes of the voltages applied from the zero-phase current transformer 20 to a predetermined value or less, and outputs the limited voltages to the earth leakage detection unit 40. The earth leakage detection unit 40 comprises an earth leakage detector 41 having two input terminals V_IN respectively connected to the output terminals of the protection unit 30, that is, the other end of the resistor R1 and the other end of the resistor R2, and an output terminal OUTPUT connected to the control signal output unit 50, a resistor R3 connected between the power terminal VCC of the earth leakage detector 41 and the switching unit 80, and a capacitor C1 connected between the power terminal VCC and the ground. Such an earth leakage detection unit 40 further comprises a thyristor (Silicon Controlled Rectifier: SCR) and a varistor connected in parallel with the thyristor SCR, and functions to protect the thyristor SCR against a large voltage variation. Such a varistor may be omitted.

The earth leakage detector 41 of the earth leakage detection unit 40 is configured to, when voltages are not applied from the protection unit 30 to the input terminals V_IN (i.e., when a voltage difference between both the input terminals V_IN is 0 V), output an earth leakage detection signal in a first state through the output terminal OUTPUT, and when the voltages are applied from the protection unit 30 to the input terminals V_IN, and a voltage difference occurs between both the input terminals V_IN, output an earth leakage detection signal in a second state (that is, an earth leakage detection signal capable of operating the main power cutoff unit) through the output terminal OUTPUT, the second state being different from the first state. In the present embodiment, the first state is a state enabling the control signal output unit 50 to be maintained in an inactive state, and the second state is a state enabling the control signal output unit 50 to be maintained in an active state. As an example, the first state may be a low-level state, and the second state may be a high-level state.

When a difference between the voltages output from the protection unit 30 occurs, the earth leakage detection unit 40 outputs an earth leakage detection signal for operating the main power cutoff unit 10, and controls the cutoff of the power that is applied to the load 10.

The resistor R3 and the capacitor C1 function as a smoothing circuit for eliminating a ripple component contained in a Direct Current (DC) component.

The control signal output unit 50 comprises the thyristor SCR having a gate terminal connected to the output terminal OUTPUT of the earth leakage detector 41, a cathode connected to the ground, and an anode connected to the switching unit 80.

The thyristor SCR of the control signal output unit 50 is conducting when a second state-earth leakage detection signal is applied from the earth leakage detection unit 40 to the gate terminal of the thyristor SCRf, and is non-conducting when a first state-earth leakage detection signal is applied to the gate terminal of the thyristor SCR.

The trip driving unit 60 comprises a trip coil TC connected at one terminal of the trip driving unit 60 to the first main power line L1, and connected at the other terminal of the trip driving unit 60 to the rectifier 70.

As described above, since the trip driving unit 60 controls the turned-on and turned-off states of the first and second switches S1 and S2 of the main power cutoff unit 10, the operating states of the first and second switches S1 and S2 are changed according to the operating state of the trip driving unit 60. Therefore, the first and second switches S1 and S2 constitute a relay in conjunction with the trip coil TC of the trip driving unit 60. In the present embodiment, the initial states of the first and second switches S1 and S2 of the relay are maintained in the states of contacts.

When it is determined by the earth leakage detection unit that the present state is a normal state other than a leakage current generation state or an earth leakage occurrence state, the relay composed of the trip coil TC and the first and second switches S1 and S2 is maintained in an inactive state, wherein the first and second switches S1 and S2 of the trip driving unit 60 at this time are maintained in a turned-on state.

In contrast, when it is determined by the earth leakage detection unit 40 that the present state is a leakage current generation state or an earth leakage occurrence state, current flows through the trip coil TC and the relay enters an active state, wherein the first and second switches S1 and S2 at this time are turned off.

The rectifier 70 full-wave rectifies the voltages applied from the main power lines L1 and L2, and then supplies power necessary for the operations of components connected to the rectifier 70, that is, the earth leakage detection unit 40, the control signal output unit 50, and the switching unit 80. In the present embodiment, such a rectifier 70 is implemented as a bridge rectification circuit, but is not limited thereto.

In the present embodiment, the rectifier 70 is a bridge rectification circuit composed of a total of eight diodes by adding a diode to each diode branch of a bridge rectification circuit composed of four diodes.

When an impulsive voltage (e.g., a surge voltage) generated at an input voltage is greater than the withstanding voltage of the bridge diodes, the breakdown of the rectifier 70 in the bridge rectification circuit composed of four diodes is caused. However, in the present embodiment, the rectifier 70 is composed of eight diodes, and individual diodes are connected in series to divide the voltage, so that the withstanding voltage of the rectifier 70 is increased twice, thus greatly reducing a possibility of breaking down the rectifier 70 due to an impulsive voltage.

The switching unit 80 comprises a relay RL comprising a third switch SW1 having an input terminal connected to the resistor R3 of the earth leakage detection unit 40 and first and second output terminals 1 and 2 individually connected to the output terminal of the rectifier 70, a fourth switch SW2 having an input terminal connected to the anode of the thyristor SCR of the control signal output unit 50 and a first output terminal 3 connected to the output terminal of the rectifier 70, and a coil L11 connected to the output terminal of the rectifier 70, a capacitor C2 connected to the output terminal of the rectifier 70, a capacitor C3 connected between the output terminal of the rectifier 70 and the ground, a resistor R4 connected to the other end of the coil L11 and the second output terminal 4 of the fourth switch SW2, and an operating state display unit 81 connected to the other end of the capacitor C2 and the second output terminal 4 of the fourth switch SW2.

When current does not flow through the coil L11, that is, when the relay RL is not operated or is in an initial state, the input terminals of the first and second switches SW1 and SW2 of the relay RL are in contact with the second output terminals 2 and 4, respectively. In contrast, when current flows through the coil L11 and the relay RL is in an active state, the contact states of the input terminals of the first and second switches SW1 and SW2 of the relay RL are changed such that they come into contact with the first output terminals 1 and 3, respectively.

In this case, when the operating state of the relay RL is switched, that is, while the state of the contact of the input terminal of the third switch SW1 changes from the second output terminal 2 to the first output terminal 1 or from the first output terminal 1 to the second output terminal 2, the voltage applied from the rectifier 70 to the power terminal VCC of the earth leakage detection unit 40 is cut off, and then the operation of the earth leakage detection unit 40 is stopped. In this state, when the change operation of the third switch SW1 is completed and the state of a contact with the earth leakage detection unit 40 is changed, the supply of voltage from the rectifier 70 to the power terminal VCC is resumed, and thus the earth leakage detection unit 40 is initialized when the supply of voltage to the power terminal VCC is resumed.

When the operating state of the relay RL is switched and the state of the contact of the fourth switch SW2 with the control signal output unit 50 changes, that is, while the contact of the input terminal of the fourth switch SW2 changes from the second output terminal 4 to the first output terminal 3 or from the first output terminal 3 to the second output terminal 4, the voltage applied to the anode of the thyristor SCR of the control signal output unit 50 is cut off. By the voltage cutoff operation of the thyristor SCR, the state of the thyristor SCR is initialized, and thus the thyristor SCR that is maintained in a conducting state is initialized to a non-conducting state in response to the second state earth leakage detection signal.

The operating state display unit 81 comprises a light emitting diode LED connected at the anode of the LED to the other end of the capacitor C2, a resistor R5 connected at one end of the resistor R5 to the cathode of the LED and connected at the other end thereof to the second output terminal 4 of the fourth switch SW2, and a number-of-leakages output unit 82 interposed between one end of the coil L11 of the relay RL and the cathode of the LED.

Such an operating state display unit 81 is connected both to the capacitor C2 and to the control signal output unit 50 and is operated to display a leakage current generation state when the control signal output unit 50 is operated.

When the thyristor SCR of the control signal output unit 50 is conducting in response to the second state earth leakage detection signal output from the earth leakage detection unit 40, the LED of the operating state display unit 81 is operated to emit light. However, when the state of the contact of the fourth switch SW2 changes from a contact with the second output terminal 4 to a contact with the first output terminal 3 by means of the operation of the relay RL, the state of the LED changes to a turned-off state.

The LED is turned on whenever the earth leakage detection unit 40 detects a leakage current generation state or an earth leakage occurrence state and outputs a second state earth leakage detection signal. Thus, the user determines whether an earth leakage has occurred using the turned-on state and the turned-off state of the LED.

The number-of-leakages output unit 82 counts the number of times that the LED is turned on, and displays the counted number of times to the user via a display device (not shown), such as a liquid crystal display device (LCD).

For this, the number-of-leakages output unit 82 may comprise a counter for counting the number of times that the LED is turned on, and a display device for displaying the corresponding number of times in response to a signal output from the counter.

Owing to the number-of-leakages output unit 82, the user may exactly and promptly determine the number of times that a leakage current is generated.

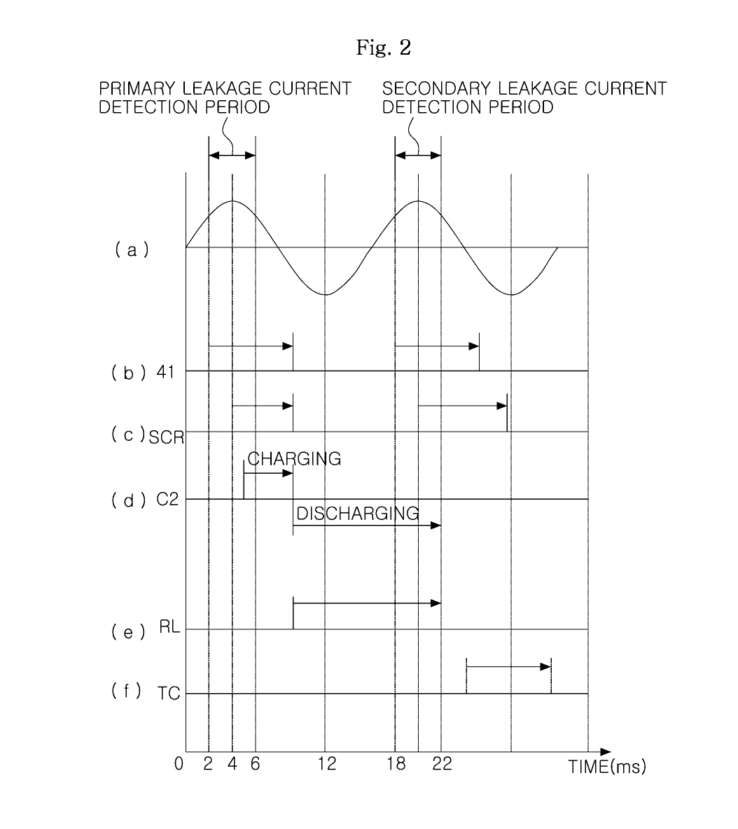

The operation of the earth leakage circuit breaker having such a structure will be described with reference to FIG. 2.

First, when the voltage of commercial power is applied to the first and second main power lines L1 and L2, drive power for the load 100, which is identical to the commercial power, is supplied to the load 100 through the first and second switches S1 and S2 that are maintained in turned-on states, that is, initial states.

Further, the voltage applied to the first and second main power lines L1 and L2 passes through the zero-phase current transformer 20, and is then applied to the trip coil TC of the trip driving unit 60 and applied to the rectifier 70 through the trip coil TC.

The rectifier 70 full-wave rectifies an applied AC voltage and applies the rectified voltage to the switching unit 80.

The voltage output at the output terminal of the rectifier 70 is applied to the power terminal VCC of the earth leakage detection unit 40 via the third switch SW1 of the relay RL that is maintained in the state of initial contact with the second output terminal 2, and then a drive voltage is supplied to the earth leakage detection unit 40. Accordingly, the operation of the earth leakage detection unit 40 is initiated.

Current flowing through the first and second main power lines L1 and L2 is applied to the rectifier 70 after passing through the trip coil TC and then current flows through the trip coil TC. However, since the magnitude of the current flowing through the trip coil TC is not large enough to change the contact states of the first and second switches S1 and S2, the relay composed of the first and second switches S1 and S2 and the trip coil TC is not operated and the first and second switches S1 and S2 are maintained in their initial states.

In such an initial operating state, when the normal state in which a leakage current is not generated due to an earth leakage or the like is maintained, voltage is not generated from the zero-phase current transformer 20 (i.e., a voltage difference between both ends of the zero-phase current transformer 20 is 0 V).

When a difference between the currents of the first main power line L1 and the second main power line L2 does not occur, an earth leakage is not found to occur, so that the magnitudes of the currents flowing through the two main power lines L1 and L2 are identical to each other, with the result that the zero-phase current transformer 20 does not generate voltage. The zero-phase current transformer 20 outputs voltages having magnitudes proportional to a current difference between the two main power lines L1 and L2 only when the current difference occurs. Therefore, since the voltages are not generated from the zero-phase current transformer 20 in the normal state, a voltage difference does not occur between the input terminals V_IN, and thus the earth leakage detection signal output from the earth leakage detection unit 40 is maintained in the first state, that is, the initial state. Accordingly, the thyristor SCR of the control signal output unit 50 is also maintained in the non-conducting state, that is, the initial state. Therefore, states of the third and fourth switches SW1 and SW2 of the relay RL are also maintained in the initial states thereof.

However, as shown in (a) of FIG. 2, in an abnormal state in which a leakage current occurs in the main power lines L1 and L2 due to an earth leakage or the like, and a current difference occurs between the two main power lines L1 and L2, the zero-phase current transformer 20 generates voltages and outputs the voltages to the protection unit 30.

The voltages applied to the protection unit 30 are dropped by the first resistor R1 and the second resistor R2 and are primarily buffered, and then the buffered voltages are applied to the first and second diodes D1 and D2.

In this case, when the magnitude of the voltage passing through the resistor R1 is equal to or greater than the threshold voltage of the second diode D2, the second diode D2 is turned on, and current corresponding to the voltage equal to or greater than the threshold voltage of the second diode D2 passes through the second diode D2 and the second resistor R2, and then flows into the zero-phase current transformer 20.

Similarly, when the magnitude of the voltage dropped by the resistor R2 is equal to or greater than the threshold voltage of the first diode D1, the first diode D1 is turned on. Current corresponding to the voltage that is equal or greater than the threshold voltage and that has passed through the resistor R2 passes through the second resistor R1 via the turned-on first diode D1, and then flows into the zero-phase current transformer 20.

Due thereto, when voltages are generated by the zero-phase current transformer 20 and are output through the two output terminals, and when the voltages that passed through the first and second resistors R1 and R2 are equal to or greater than the threshold voltage of the second and first diodes D2 and D2, currents corresponding to the voltages equal to or greater than the threshold voltage are fed back to the zero-phase current transformer 20 by means of the turn-on operations of the second and first diodes D2 and D1, and a voltage difference corresponding to the threshold voltages is generated between the input terminals V_IN of the earth leakage detection unit 40.

By the operation of the protection unit 30, the voltage difference between the input terminals V_IN of the earth leakage detector 41 of the earth leakage detection unit 40 has a magnitude identical to that of the threshold voltages of the first and second diodes D1 and D2.

However, when the magnitudes of the voltages that are generated by the zero-phase current transformer 20 and that have passed through the first and second resistors R1 and R2 are less than the threshold voltages of the first and second diodes D1 and D2, the first and second diodes D1 and D2 are not turned on, and thus the voltages are directly applied to the input terminals V_IN of the earth leakage detector 41 of the earth leakage detection unit 40.

The voltage difference between the input terminals V_IN of the earth leakage detector 41 has a value less than the threshold voltages of the first and second diodes D1 and D2.

As described above, as a difference between the currents of the two main power lines L1 and L2 is larger, the magnitudes of the voltages generated from the zero-phase current transformer 20 are increased in proportion to the current difference.

However, in the case of the present embodiment, the voltage difference between the input terminals V_IN of the earth leakage detector 41 of the earth leakage detection unit 40 always has a value less than the first and second threshold voltages regardless of the magnitudes of the voltages generated by the zero-phase current transformer 20, thus preventing the earth leakage detection unit 40 from breaking down due to the voltages generated by the zero-phase current transformer 20.

When the voltages are generated from the zero-phase current transformer 30 and a voltage difference occurs between the input terminals V_IN of the earth leakage detector 41 of the earth leakage detection unit 40, the earth leakage detector 41 of the earth leakage detection unit 40 outputs a second state earth leakage detection signal through the output terminal OUTPUT, as shown in (b) of FIG. 2. That is, when the voltage difference occurs between the input terminals V_IN, the earth leakage detector 41 determines that an earth leakage has occurred, and then outputs a second state earth leakage detection signal. In this way, when the voltage difference occurs between the input terminals V_IN, the earth leakage detector 41 changes the state of the earth leakage detection signal that is output through the output terminal OUTPUT from a first state to a second state.

When the state of the earth leakage detection signal that is applied to the gate of the thyristor SCR of the control signal output unit 50 has changed from the first state to the second state, the state of the thyristor SCR changes from a non-conducting state to a conducting state after a predetermined delay time has elapsed, as shown in (c) of FIG. 2. In this case, the thyristor SCR is a latch element for maintaining a conducting state even when a conducting signal applied to the gate is cut off.

As the thyristor SCR of the control signal output unit 50 is conducting, current output from the rectifier 70 passes through the LED and the resistor R5 of the operating state display unit 81 via the capacitor C2, and then flows through the third switch SW3 connected to the second output terminal 4 and the thyristor SCR into the ground.

As shown in (d) of FIG. 2, the charging operation of the capacitor C2 is started, and the LED is turned on. As shown in (d) o FIG. 2, the capacitor C2 may be charged for a time of about 2 ms to 3 ms.

In this case, for the time required for the relay RL to be operated due to the operation of the thyristor SCR of the control signal output unit 50, that is, for the charging time of the capacitor C2, the trip driving unit 60 may be operated by current flowing through the trip driving unit 60 to the rectifier 70 and the control signal output unit 50, but the current flowing through the control signal output unit 50 does not have a high enough magnitude to operate the trip driving unit 60 due to the resistor R4 connected in series with the coil L11 of the relay RL and the resistor R5 connected in series with the capacitor C2. Therefore, while the capacitor C2 is charged, the trip driving unit 60 is maintained in an initial state without operating the first and second switches S1 and S2. In this way, the values of the resistors R4 and R5 for adjusting the amount of current flowing through the trip coil TC may be changed as necessary.

When the charging of the capacitor C2 is completed in the conducting state of the thyristor SCR, current output from the rectifier 70 passes through the coil L11 of the relay RL and the resistor R1, and then flows through the second output terminal 4, the fourth switch SW2 of the relay RL which is maintained in the initial state thereof, and the conducting thyristor SCR into the ground, as shown in (e) of FIG. 2.

The inactive state of the relay RL thereby changes to an active state. Depending on the operation of the relay RL, the states of the switches SW1 and SW2 change from initial states to active states. Therefore, the input terminals of the third and fourth switches SW1 and SW2 come into contact with the first output terminals 1 and 3, respectively.

In this case, in order to drive the third and fourth switches SW1 and SW2, the coil L11 is operated for a time of 10 ms or longer. Referring to (e) of FIG. 2, it can be seen that, before the coil L11 is operated, the capacitor C2 has already been charged.

By means of the operation of the relay RL, when the connections of the input terminals of the third and fourth switches SW1 and SW2 from the second output terminals 2 and 4 to the first output terminals 1 and 3 have been completed, the voltage output from the rectifier 70 is applied to the power terminal VCC of the earth leakage detector 41 of the earth leakage detection unit 40 through the third switch SW1 of the relay RL, and then the drive voltage is supplied to the earth leakage detector 41. Further, the voltage charged in the capacitor C2 starts to be discharged, as shown in (d) of FIG. 2, and at this time, the capacitor C2 is discharged through the coil L11. Due to the discharging operation of the capacitor C2, the relay RL is maintained in the active state until the discharging of the capacitor C2 is completed, so that, during the discharging period of the capacitor C2, the input terminals of the third and fourth switches SW1 and SW2 of the relay RL are maintained in the states of being connected to the first output terminals 1 and 3.

As described above, when the contact states of the third and fourth switches SW1 and SW3 change from the initial states to active states, the LED is maintained in a turned-off state.

During a period in which, by means of the operation of the relay RL, the contact states of the input terminals of the third and fourth switches SW1 and SW2 of the relay RL change from the second output terminals 2 and 4 corresponding to initial states to the first output terminals 1 and 3 corresponding to active states, that is, a period in which the input terminals are disconnected from the second output terminals 2 and 4 and are not yet connected to the first output terminals 1 and 3 (hereinafter referred to as “switch contact change period”), the input terminals of the third and fourth switches SW1 and SW2 of the relay RL are not yet connected to any of the first and second output terminals 1, 3, 2, and 4.

During the switch contact change period, the voltage output from the rectifier 70 is not applied to the power terminal VCC of the earth leakage detector 41 of the earth leakage detection unit 40 through the third switch SW1, so that the supply of the voltage to the earth leakage detector 41 of the earth leakage detection unit 40 is cut off, thus stopping the operation of the earth leakage detector 41 and causing the LED to change from the a turned-on state to a turned-off state.

Since there is no signal output through the output terminal OUTPUT of the earth leakage detector 41, the operation of the thyristor SCR of the control signal output unit 50 connected to the output terminal OUTPUT is also stopped.

As described above, when the contact change operations of the third and fourth switches SW1 and SW2 of the relay RL have been completed, that is, when connections between the input terminals of the third and fourth switches SW1 and SW2 and the first output terminals 1 and 3 have been completed, the supply of voltage to the earth leakage detector 41 of the earth leakage detection unit 40 is resumed. By the supply of the voltage, the earth leakage detector 41 of the earth leakage detection unit 40 is initialized. Further, due to the initialization operation of the earth leakage detector 41, the state of the output terminal OUTPUT of the earth leakage detector 41 is maintained in a first state that is an initial state, and thus the state of the thyristor SCR of the control signal output unit 50 becomes an initial state and changes from a conducting state to a non-conducting state.

Due to the initialization operation of the earth leakage detection unit 40 and the control signal output unit 50, the earth leakage detector 41 of the earth leakage detection unit 40 enters a state in which the generation of a leakage current can be detected.

In a secondary earth leakage monitoring state in which, due to the resumption of the supply of voltage, the earth leakage detector 41 of the earth leakage detection unit 40 and the thyristor SCR of the control signal output unit 50 are in initial states, and in which, due to the discharging of the capacitor C2, the relay RL is continuously maintained in the active state, when a voltage difference between the input terminals V_IN of the earth leakage detector 41 of the earth leakage detection unit 40 occurs, the earth leakage detector 41 applies a second state earth leakage detection signal to the gate of the thyristor 51 of the control signal output unit 50.

Due thereto, the state of the thyristor 51 changes from the non-conducting state to the conducting state.

Through a path indicated by ‘\textcircled{1}’ in FIG. 1, current from the commercial power flows from the first main power line L1 to the second main power line L2.

As a result, as shown in (f) of FIG. 2, current flows into the trip coil TC of the trip driving unit 60 forming the relay and enables the relay to operate, and thus the states of the first and second switches S1 and S2 connected to the trip coil TC change from the initial states to active states, thus causing the first and second switches S1 and S2 to be turned off.

By means of the turn-off operations of the first and second switches S1 and S2, the power supplied from the first and first main power lines L1 and L2 to the load 100 is cut off, thus preventing the load 100 from being damaged by the leakage current generated due to an earth leakage or the like.

In the secondary earth leakage monitoring state, when a voltage difference does not occur between the input terminals V_IN of the earth leakage detector 41 of the earth leakage detection unit 40, when the discharging operation of the capacitor C2 is completed, the state of the relay RL changes to the inactive state, and the states of connections of the third and fourth switches SW1 and SW2 change to the initial states, thus causing the input terminals of the third and fourth switches SW1 and SW2 to be connected to the second output terminals 2 and 4, respectively.

The number-of-leakages output unit 81 is connected to the cathode of the LED, and is configured to count the number of times that the LED changes from a turned-on state to a turned-off state or from the turned-off state to the turned-on state, that is, the number of turn-on operations or turn-off operations of the LED, by using the signal state of the cathode, and outputs a signal corresponding to the counted number of times via the display device.

The display device externally displays the number of times using the applied signal. By the operation of the number-of-leakages output unit 82, the user may easily and promptly check the number of times that an earth leakage occurs.

In this way, only when the state of earth leakage occurrence is detected again within a predetermined time, that is, before the discharging operation of the capacitor C2 is completed, after the state of earth leakage occurrence has been detected by the earth leakage detection unit 400, the supply of the power through the first and second main power lines L1 and L2 is cut off.

Since the operation of unnecessarily cutting off the power supplied through the first and second main power lines L1 and L2 due to an instantaneously generated leakage current attributable to noise or the like is prevented, the user's convenience is improved, and the reliability of the earth leakage circuit breaker is improved.

Since the magnitude of the voltage transferred to the earth leakage detection unit 40 is limited owing to the operation of the protection unit 30, the breakdown and malfunctioning of the earth leakage detection unit 40 are prevented using the output voltage of the zero-phase current transformer 20 having a magnitude proportional to the amount of leakage current.

Although embodiments of the disclosure have been described in detail, the scope is not limited to those embodiments, and it should be noted that various modifications and changes made by those skilled in the art based on the basic concept of the present disclosure defined in the accompanying claims belong to the scope of the present disclosure.

1. An earth leakage circuit breaker, comprising:
a main power cutoff unit connected between main power lines supplied with power and a load;
a zero-phase current transformer connected to the main power lines and configured to detect a leakage current generated on the main power lines and output voltages having magnitudes corresponding to the detected leakage current through first and second output terminals;
a protection unit connected to the zero-phase current transformer and configured to limit the magnitudes of the voltages output from the zero-phase current transformer to a preset value or less and output limited voltages; and
an earth leakage detection unit connected to the protection unit and configured to, when a difference between the voltages output from the protection unit occurs, output an earth leakage detection signal for driving the main power cutoff unit and then controlling cutoff of the power applied to the load.

2. The earth leakage circuit breaker of claim 1, wherein the protection unit comprises a first diode and a second diode connected to the output terminals of the zero-phase current transformer and to the earth leakage detection unit in opposite directions.

3. The earth leakage circuit breaker of claim 1, wherein the preset value is a threshold voltage of the first and second diodes.

4. The earth leakage circuit breaker of claim 2, wherein the protection unit further comprises a first resistor connected at a first end of the first resistor to the first output terminal of the zero-phase current transformer and connected at a second end of the first resistor to a cathode of the first diode, and a second resistor connected at a first end of the second resistor to the second output terminal of the zero-phase current transformer and connected at a second end of the second resistor to a cathode of the second diode,
wherein an anode of the first diode is connected to the cathode of the second diode, and an anode of the second diode is connected to the cathode of the first diode.

5. The earth leakage circuit breaker of claim 1, further comprising:
a control signal output unit connected to the earth leakage detection unit and configured to control an operating state of the control signal output unit in response to a state of the earth leakage detection signal output from the earth leakage detection unit;
a switching unit provided with a relay for initializing the earth leakage detection unit and the control signal output unit, and a capacitor for maintaining an operating time of the relay;
a trip driving unit connected to the main power lines and configured to operate the main power cutoff unit depending on operating states of the control signal output unit and the switching unit and then cut off power the that is supplied from the main power lines to the load; and
a rectifier connected to the main power lines and the trip driving unit and configured to supply power to the earth leakage detection unit and to the switching unit.

6. The earth leakage circuit breaker of claim 5, wherein the relay comprises:
a coil, a third switch configured to change a state of a contact with the earth leakage detection unit and to initialize the earth leakage detection unit when current flows through the coil, and a fourth switch configured to change a state of a contact with the control signal output unit and to initialize the control signal output unit when current flows through the coil.

7. The earth leakage circuit breaker of claim 5, wherein the switching unit is configured to operate the relay during a time in which the capacitor is discharged, and is configured to, when a leakage current is detected by the zero-phase current transformer during a time in which the relay is operated, operate the trip driving unit and then cut off the power that is supplied from the main power lines to the load.

8. The earth leakage circuit breaker of claim 5, wherein the switching unit is connected both to the capacitor and to the control signal output unit, and is operated to display a leakage current generation state when the control signal output unit is operated.

9. The earth leakage circuit breaker of claim 8, wherein the operating state display unit comprises a light emitting diode (LED).

10. The earth leakage circuit breaker of claim 9, wherein the operating state display unit further comprises a number-of-leakages output unit for counting a number of times that the LED is turned on or turned off, and outputting the counted number of times.

11. The earth leakage circuit breaker of claim 5, wherein the rectifier is a bridge rectification circuit.

12. The earth leakage circuit breaker of claim 11, wherein the rectifier comprises eight diodes connected in series.
